(19) United States
(12) Patent Application Publication
(10) Pub. No.: US 2025/0368053 A1
(43) Pub. Date: Dec. 4, 2025

(54) ELECTRIC VEHICLE DRIVE SYSTEM

(71) Applicant: Mitsubishi Electric Corporation, Chiyoda-ku, Tokyo (JP)

(72) Inventor: Hirokazu TAKABAYASHI, Tokyo (JP)

(73) Assignee: Mitsubishi Electric Corporation, Chiyoda-ku, Tokyo (JP)

(21) Appl. No.: 18/875,385

(22) PCT Filed: Aug. 1, 2022
(86) PCT No.: PCT/JP2022/029508

§ 371 Date: Dec. 16, 2024

(51) Int. Cl. B60L 15/00; B60L 9/18

(52) U.S. Cl. CPC B60L 15/007; B60L 9/18; B60L 2200/26; B60L 2210/44

(57) ABSTRACT

An electric vehicle drive system includes a first control device that controls electric motors that drive axles of a first cart of an electric vehicle, and a second control device that controls electric motors that drive axles of a second cart. The control devices each include an inverter and a controller that controls the inverter. The first control device is housed in a first housing, and the second control device is housed in a second housing. Coolers that perform cooling using a relative air flow are attached to the housings, respectively. The control devices are dispersedly disposed near the first cart and near the second cart.

### FIELD

The present disclosure relates to an electric vehicle drive system including a plurality of electric vehicle control devices for controlling electric motors that drive an electric vehicle.

### BACKGROUND

An electric vehicle control device (hereinafter conveniently abbreviated as a “control device”) operates by receiving power from an overhead line, and thus is often installed on a roof or under a floor of an electric vehicle. The control device includes an inverter in which semiconductor elements are incorporated. The inverter is electrically connected to an electric motor for traveling. Direct current power is supplied to the inverter. The direct current power is converted into desired alternating current power by switching operation of the semiconductor elements of the inverter and is supplied to the electric motor. The electric motor is driven by the converted alternating current power. The semiconductor elements of the inverter generate heat when performing the switching operation. Therefore, a cooler is attached to a housing that houses the inverter.

Patent Literature 1 below discloses a configuration in which, for a relative air flow-utilizing cooler that cools an inverter with a relative air flow generated when an electric vehicle travels, two of the coolers are placed close to each other in series along a forward direction of the electric vehicle.

### CITATION LIST

### Patent Literature

Patent Literature 1: Japanese Patent No. 6494408

### SUMMARY OF INVENTION

### Problem to be Solved by the Invention

However, with the configuration of Patent Literature 1, it is difficult to efficiently cool a plurality of the inverters. For example, when the area of the coolers is divided into a windward side and a leeward side with respect to the relative air flow, the inverter cooled by the cooler located on the windward side is easily cooled due to the relative air flow being taken in efficiently. On the other hand, for the inverter cooled by the cooler located on the leeward side, the relative air flow is less easily taken into the cooler on the leeward side due to the two coolers being close to each other, and also the temperature of the relative air flow tends to be increased due to the influence of heat generated by the inverter located on the windward side, which results in difficult cooling conditions.

Therefore, in order to achieve sufficient cooling on the leeward side, a high-performance cooler using a heat pipe or a large-sized cooler may need to be applied. Moreover, Patent Literature 1 adopts a structure in which an air guide is provided for guiding the relative air flow to the cooler on the leeward side. In any case, the conventional method has a problem in that the size of the control device and the manufacturing cost of the control device increase.

Also, in a case where the control device is installed under the floor of the electric vehicle, the space under the floor is limited, so that there may not be sufficient space for installing the housing of the control device. In such a case, it is necessary to downsize components by changing the specifications of the control device or the like, and to downsize the housing. Note that by revising the specifications, there may be a disadvantage that the function or performance of the electric vehicle is reduced from the initial state.

The present disclosure has been made in view of the above, and an object thereof is to provide an electric vehicle drive system in which control devices can be flexibly disposed in a limited space of an electric vehicle such that efficient cooling can be performed.

### Means to Solve the Problem

In order to solve the above problem and achieve the object, an electric vehicle drive system according to the present disclosure includes a plurality of control devices that each control at least one of four electric motors that drive four axles of two carts of an electric vehicle. Each of the control devices includes an inverter that supplies power to at least one of the electric motors, and a controller that controls the inverter. The inverter is housed in a housing together with the controller, and the housing houses at least one of the control devices. A cooler that cools the inverter using a relative air flow generated by traveling of the electric vehicle is attached to the housing. The plurality of the control devices are dispersedly disposed near a first cart located on a front side of the electric vehicle with respect to a forward direction and near a second cart located on a rear side with respect to the forward direction.

### Effects of the Invention

The electric vehicle drive system according to the present disclosure has an effect that the control devices can be flexibly disposed in the limited space of the electric vehicle such that efficient cooling can be performed.

### BRIEF DESCRIPTION OF DRAWINGS

FIG. 1 is a diagram illustrating an exemplary configuration of an electric vehicle drive system according to a first embodiment.

FIG. 2 is a diagram illustrating conventional exemplary installation illustrated as a comparative example.

FIG. 3 is a first diagram for explaining first exemplary installation of the electric vehicle drive system according to the first embodiment.

FIG. 4 is a second diagram for explaining the first exemplary installation of the electric vehicle drive system according to the first embodiment.

FIG. 5 is a diagram for explaining second exemplary installation of the electric vehicle drive system according to the first embodiment.

FIG. 6 is a diagram for explaining third exemplary installation of the electric vehicle drive system according to the first embodiment.

FIG. 7 is a diagram for explaining fourth exemplary installation of the electric vehicle drive system according to the first embodiment.

FIG. 8 is a diagram illustrating results of a first verification test for explaining an influence of an obstacle on a relative air flow that flows to a cooler.

FIG. 9 is a diagram illustrating results of a second verification test for explaining the influence of the obstacle on the relative air flow that flows to the cooler.

FIG. 10 is a diagram for explaining exemplary installation of an electric vehicle drive system according to a second embodiment.

### DESCRIPTION OF EMBODIMENTS

Hereinafter, an electric vehicle drive system according to embodiments of the present disclosure will be described in detail with reference to the drawings. Note that in the accompanying drawings, for easy understanding, the scale of each member may be different from the actual scale. This is also true between the drawings. Moreover, in the following description, physical connection and electrical connection are not distinguished from each other and are simply referred to as “connection”. That is, the term “connection” includes both a case where components are directly connected to each other and a case where components are indirectly connected to each other via another component.

### First Embodiment

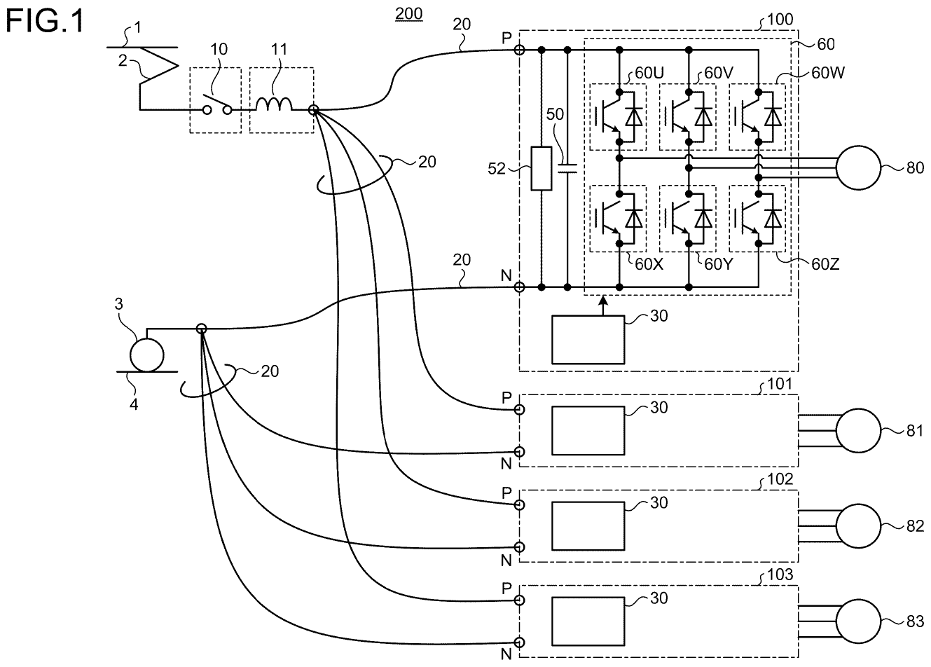

FIG. 1 is a diagram illustrating an exemplary configuration of an electric vehicle drive system according to a first embodiment. FIG. 1 illustrates the exemplary configuration for one car of an electric vehicle.

As illustrated in FIG. 1, an electric vehicle drive system 200 includes four control devices 100 to 103 that receive direct current power from an overhead line 1 via a current collector 2. There is a substation (not illustrated) beyond the overhead line 1, and the overhead line 1 is regarded as an external power supply when viewed from the control devices 100 to 103. An overhead line voltage, which is a voltage of the overhead line 1 applied to the current collector 2, and transformation capacities of the control devices 100 to 103 vary depending on the driving scheme of the electric vehicle drive system. The overhead line voltage ranges approximately from 600 to 3000 [V]. The transformation capacity ranges from several tens to several hundreds of [kVA].

The control devices 100 to 103 are connected to four electric motors 80 to 83 for driving the electric vehicle, respectively. The direct current power supplied from the overhead line 1 and the current collector 2 is supplied to the control devices 100 to 103 via a switch 10, a reactor 11, and electric wires 20. Positive terminals “P” of the control devices 100 to 103 are connected to the reactor 11. Negative terminals “N” of the control devices 100 to 103 are connected to a rail 4 via a wheel 3. As a result, a direct current of the direct current power supplied from the overhead line 1 flows through the switch 10, the reactor 11, the electric wires 20, the control devices 100 to 103, the electric motors 80 to 83, the wheel 3, and the rail 4, and returns to the substation. In the configuration of FIG. 1, the reactor 11, the electric wires 20, and the control devices 100 to 103 are components of the electric vehicle drive system 200. The electric wires 20 include a conductor such as copper or aluminum. An example of the conductor is a bus bar.

Note that in FIG. 1, an overhead electric wire is illustrated as the overhead line 1, and a pantograph current collector is illustrated as the current collector 2, but the present disclosure is not limited thereto. The overhead line 1 may be a third rail used in subways and the like, and accordingly, the current collector 2 may be a current collector for the third rail. Although FIG. 1 illustrates a case where the overhead line 1 is a direct current overhead line, the overhead line 1 may be an alternating current overhead line. Note that in the case where the overhead line 1 is the alternating current overhead line, a transformer for stepping down an alternating current voltage of received power is provided between the current collector 2 and the switch 10 or between the switch 10 and the reactor 11, and a converter for converting the alternating current voltage output from the transformer into a direct current voltage is provided at a subsequent stage of the transformer.

The control device 100 includes a capacitor 50 that holds the direct current voltage, a discharge circuit 52 that discharges the voltage of the capacitor 50, and an inverter 60. The capacitor 50 and the discharge circuit 52 are connected between the positive terminal “P” and the negative terminal “N” inside the control device 100. As a result, the capacitor 50 and the discharge circuit 52 are connected in parallel to both ends of the inverter 60 on an input side of the inverter 60.

The capacitor 50 is connected to the reactor 11 and constitutes an LC filter circuit together with the reactor 11. The LC filter circuit reduces a surge voltage entering from the side of the overhead line 1. In addition, the LC filter circuit is connected to the inverter 60 and reduces the magnitude of a ripple component of the current flowing through the inverter 60.

The inverter 60 included in each of the control devices 100 to 103 is a power conversion circuit that supplies power to the corresponding one of the electric motors 80 to 83. The inverter 60 converts the direct current voltage of the capacitor 50 into an alternating current voltage of an arbitrary frequency having an arbitrary voltage value, and applies the alternating current voltage to the corresponding one of the electric motors 80 to 83.

As illustrated in FIG. 1, the inverter 60 includes six semiconductor elements 60U, 60V, 60W, 60X, 60Y, and 60Z. The semiconductor elements 60U, 60V, 60W, 60X, 60Y, and 60Z are bridge-connected to constitute a three-phase bridge circuit. Note that, although not illustrated in FIG. 1, the inverter 60 is included in each of the control devices 101 to 103 as in the control device 100.

In the inverter 60, the semiconductor elements 60U, 60V, and 60W are referred to as positive arms, and the semiconductor elements 60X, 60Y, and 60Z are referred to as negative arms. In addition, a pair of the positive arm and the negative arm connected in series is referred to as a leg. The semiconductor elements 60U and 60X constitute a U-phase leg, the semiconductor elements 60V and 60Y constitute a V-phase leg, and the semiconductor elements 60W and 60Z constitute a W-phase leg. The semiconductor elements 60U, 60V, 60W, 60X, 60Y, and 60Z are each preferably an insulated gate bipolar transistor (IGBT) element with a built-in anti-parallel diode as illustrated in the drawing. Note that, instead of the IGBT element, a metal-oxide-semiconductor field-effect transistor (MOSFET) may be used.

The control devices 100 to 103 each include a controller 30. The controller 30 generates a pulse width modulation (PWM) signal for performing PWM control on the semiconductor elements 60U, 60V, 60W, 60X, 60Y, and 60Z of the inverter 60, and applies the PWM signal to the inverter 60.

Note that FIG. 1 illustrates a configuration of a control scheme called “individual control” in which each of the four electric motors 80 to 83 is individually controlled by the corresponding one of the control devices 100 to 103, but the present disclosure is not limited to this configuration. The four electric motors 80 to 83 are installed on two carts not illustrated in FIG. 1, and thus a configuration of a control scheme called “cart control” may also be adopted in which the two electric motors installed on one cart are controlled by one control device.

Note that, in the case of the cart control scheme, the control device 100 and the control device 101 are integrated, and the inverter 60 connected to the electric motor 80 and the inverter 60 connected to the electric motor 81 are controlled by one of the controllers 30. Likewise, the control device 102 and the control device 103 are integrated, and the inverter 60 connected to the electric motor 82 and the inverter 60 connected to the electric motor 83 are controlled by one of the controllers 30.

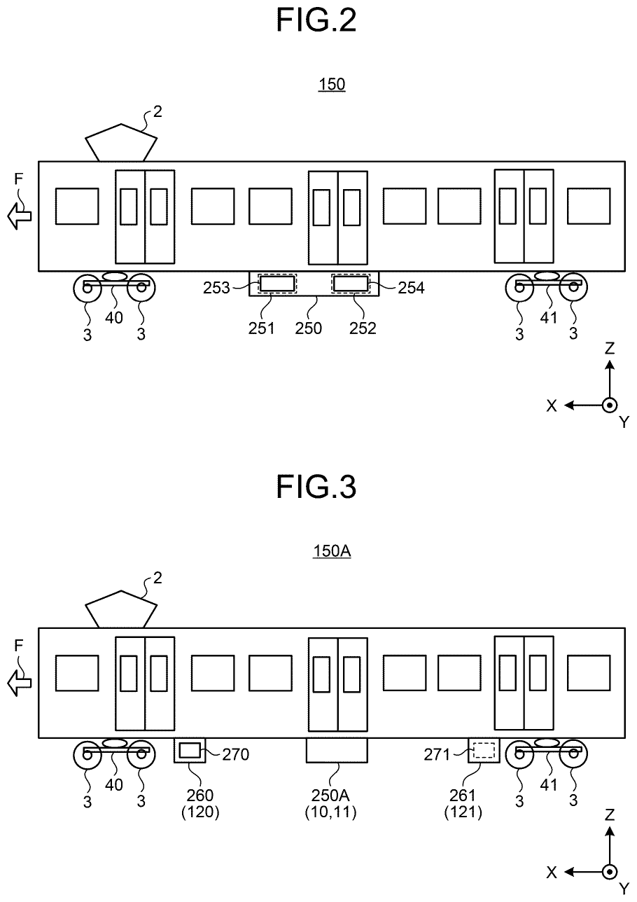

FIG. 2 is a diagram illustrating conventional exemplary installation illustrated as a comparative example. FIG. 2 uses an X axis, a Y axis, and a Z axis of a right-handed system orthogonal to one another to define a forward direction F as a +X axis direction, a horizontal direction orthogonal to the forward direction F as a Y axis direction, a vertically upward direction orthogonal to the forward direction F as a +Z axis direction, and a vertically downward direction orthogonal to the forward direction F as a −Z axis direction. Note that the subsequent drawings also use the same coordinate system as that in FIG. 2. Moreover, in this description, the Y axis direction may be referred to as a “first direction”.

In a conventional electric vehicle drive system disclosed in Patent Literature 1, for example, as illustrated in FIG. 2, a housing 250 incorporating all components of the electric vehicle drive system is installed under the floor of an electric vehicle 150. FIG. 2 illustrates the exemplary installation of the aforementioned cart control scheme, in which a cart 40 on a front side and a cart 41 on a rear side with respect to the forward direction F are each equipped with two electric motors (not illustrated). In the housing 250, a control device 251 that controls the two electric motors on the cart 40 and a control device 252 that controls the two electric motors on the cart 41 are installed. Moreover, on the housing 250, a cooler 253 for cooling an inverter included in the control device 251 and a cooler 254 for cooling an inverter included in the control device 252 are attached so as to protrude in the Y axis direction on a side surface of the housing 250. Note that although FIG. 2 does not illustrate devices installed under the floor other than the housing 250, various underfloor devices necessary for the operation of the electric vehicle 150 are actually installed. For one car of the electric vehicle 150 having a length of about 20 m, it is necessary to secure the space for installing the various underfloor devices, and the housing 250 has a length in a direction of the length of the car of at most under 2 m.

As described above, the conventional electric vehicle drive system has the configuration in which the two coolers 253 and 254 are disposed close to each other in series along the forward direction F of the electric vehicle 150. In the case of this configuration, as described in the section of “Problem to be solved by the Invention”, the inverter cooled by the cooler 253 located on the windward side of the relative air flow is easily cooled due to the relative air flow being efficiently taken into the cooler 253. On the other hand, for the inverter cooled by the cooler 254 located on the leeward side of the relative air flow, the relative air flow is less easily taken into the cooler 254 on the leeward side due to the two coolers 253 and 254 being close to each other, and also the temperature of the relative air flow taken into the cooler 254 tends to be increased due to the influence of heat generated by the inverter located on the windward side, which results in difficult cooling conditions. Patent Literature 1 adopts the structure in which the air guide is provided for guiding the relative air flow to the cooler on the leeward side, but has had the problem in that the size of the control device and the manufacturing cost thereof increase.

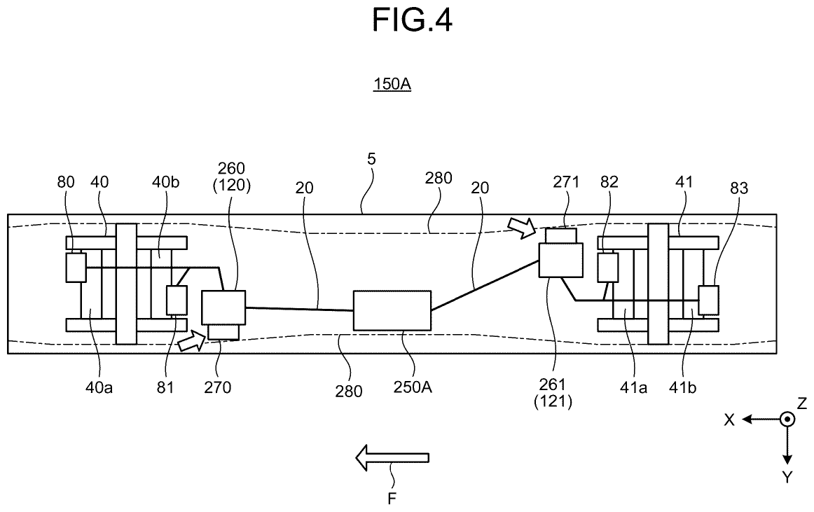

In order to address the above problem, the first embodiment first proposes exemplary installation illustrated in FIGS. 3 and 4. FIG. 3 is a first diagram for explaining first exemplary installation of the electric vehicle drive system according to the first embodiment. FIG. 4 is a second diagram for explaining the first exemplary installation of the electric vehicle drive system according to the first embodiment. FIG. 3 is a diagram of an electric vehicle 150A as viewed from a side surface side thereof toward a negative direction of the Y axis. FIG. 4 is a diagram of an underfloor space of the electric vehicle 150A through a floor surface of the electric vehicle 150A in a negative direction of the Z axis. Note that the subsequent description also uses the drawings illustrated similarly to FIGS. 3 and 4. In addition, FIGS. 3 and 4 illustrate the exemplary installation of the cart control scheme, and the number of control devices is “two” per car. Here, for convenience, one of the control devices will be described as a “control device 120”, and the other control device will be described as a “control device 121”.

In FIGS. 3 and 4, components of the electric vehicle drive system 200 are dispersedly disposed under the floor of the electric vehicle 150A. Specifically, a housing 250A that houses the switch 10 and the reactor 11 is disposed in a center portion of the underfloor space. In addition, a housing 260 that houses the control device 120 is disposed away from the center portion of the underfloor space and near the cart 40 located on a front side of the electric vehicle 150A with respect to the forward direction F, specifically, disposed behind the cart 40 and on a left side with respect to the forward direction F. Likewise, a housing 261 that houses the control device 121 is disposed away from the center portion of the underfloor space and near the cart 41 located on a rear side of the electric vehicle 150A with respect to the forward direction F, specifically, disposed in front of the cart 41 and on a right side with respect to the forward direction F.

On the housing 260, a cooler 270 for cooling the two inverters 60 included in the control device 120 is attached so as to protrude in a +Y axis direction on a side surface of the housing 260. On the housing 261, a cooler 271 for cooling the two inverters 60 included in the control device 121 is attached so as to protrude in a −Y axis direction on a side surface of the housing 261.

On the cart 40, electric motors 80 and 81 each connected to the control device 120 are installed. The electric motor 80 drives an axle 40a on a front side of the cart 40 with respect to the forward direction F, and the electric motor 81 drives an axle 40b on a rear side of the cart 40 with respect to the forward direction F.

On the cart 41, electric motors 82 and 83 each connected to the control device 121 are installed. The electric motor 82 drives an axle 41a on a front side of the cart 41 with respect to the forward direction F, and the electric motor 83 drives an axle 41b on a rear side of the cart 41 with respect to the forward direction F. Note that, in this description, the cart 40 may be referred to as a “first cart”, and the cart 41 may be referred to as a “second cart”. Also in this description, the control device 120 may be referred to as a “first control device”, and the control device 121 may be referred to as a “second control device”.

When there are heat generating objects close to each other on the windward side, the temperature of the relative air flow taken into the cooler rises. On the other hand, in the configuration of FIGS. 3 and 4, since the cooler 270 located on the windward side of the relative air flow and the cooler 271 located on the leeward side of the relative air flow are disposed with a sufficient separation distance, it may be said that there are no heat generating objects close to each other. Accordingly, in the configuration of FIGS. 3 and 4, a difference between the cooling conditions of the cooler 271 located on the leeward side and the cooling conditions of the cooler 270 located on the windward side can be reduced. As a result, the configuration of FIGS. 3 and 4 can avoid an increase in the size of the control devices 120 and 121 and an increase in the manufacturing cost of the control devices 120 and 121.

Moreover, in FIG. 4, outfitting limit lines 280 are indicated by dash-dotted lines with respect to the width of a car 5 of the electric vehicle 150A. The outfitting limit lines 280 mean boundary lines on the vehicle width side of an installation area for the objects installed under the floor. That is, the objects installed under the floor cannot be installed outside the outfitting limit lines 280. With respect to the width of the car 5, the outfitting limit lines 280 are the widest at the positions of the carts 40 and 41 and are the narrowest at the center portion of the underfloor space. Therefore, it can be said that, as compared to the configuration of the conventional technique in which the housing 250 that houses the control devices is disposed at the center portion of the underfloor space, the configuration of the first embodiment in which the housings 260 and 261 that house the control devices 100 to 103 are disposed near the carts 40 and 41 can more easily take in the relative air flow. As a result, it can be said that the configuration of FIGS. 3 and 4 is configured to enhance the cooling performance of the coolers 270 and 271 as compared to the configuration of the conventional technique in FIG. 2. Therefore, with the configuration of FIGS. 3 and 4, the control devices 120 and 121 can be disposed such that efficient cooling can be performed.

Moreover, in the configuration of FIGS. 3 and 4, the components of the electric vehicle drive system 200 are not all housed in one housing, but are separately housed in the three housings 250A, 260, and 261. As a result, although the number of the housings is increased, the size of each of the housings is reduced, so that the housings can be disposed with effective use of an empty space under the floor.

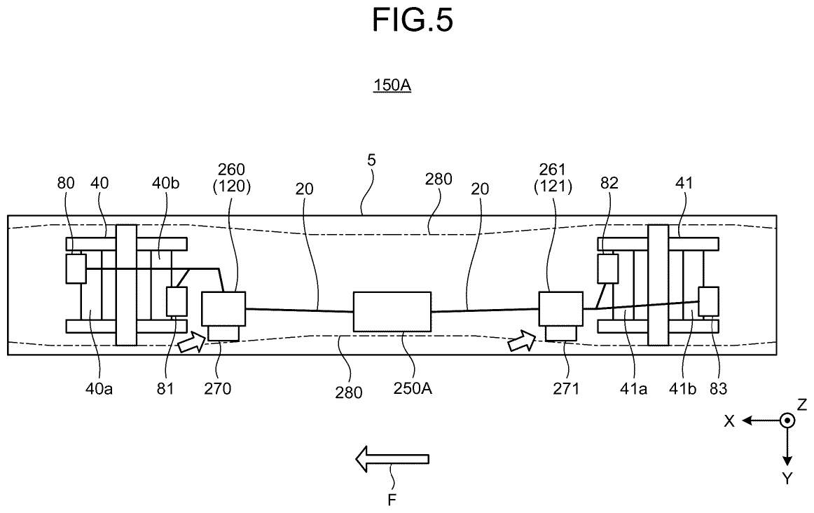

FIG. 5 is a diagram for explaining second exemplary installation of the electric vehicle drive system according to the first embodiment. In FIG. 4, the housing 260 that houses the control device 120 and the housing 261 that houses the control device 121 are disposed at diametrically opposite positions, that is, at rotationally symmetric positions as viewed from the center portion of the underfloor space. On the other hand, in FIG. 5, the housing 260 that houses the control device 120 is left as it is, and the housing 261 that houses the control device 121 is disposed in line with the housing 260, that is, at a position such that the housing 260 and the housing 261 are arranged in tandem along the forward direction F.

As illustrated in FIG. 5, even when the cooler 270 located on the windward side and the cooler 271 located on the leeward side are disposed in line with each other, the separation distance between the cooler 270 on the windward side and the cooler 271 on the leeward side is substantially the same as that in the case of FIG. 4. That is, since the cooler 270 on the windward side and the cooler 271 on the leeward side are disposed with a sufficient separation distance, it may be said that there are no heat generating objects close to each other. Therefore, the exemplary installation of FIG. 5 can also obtain an effect equivalent to that of the exemplary installation of FIG. 4.

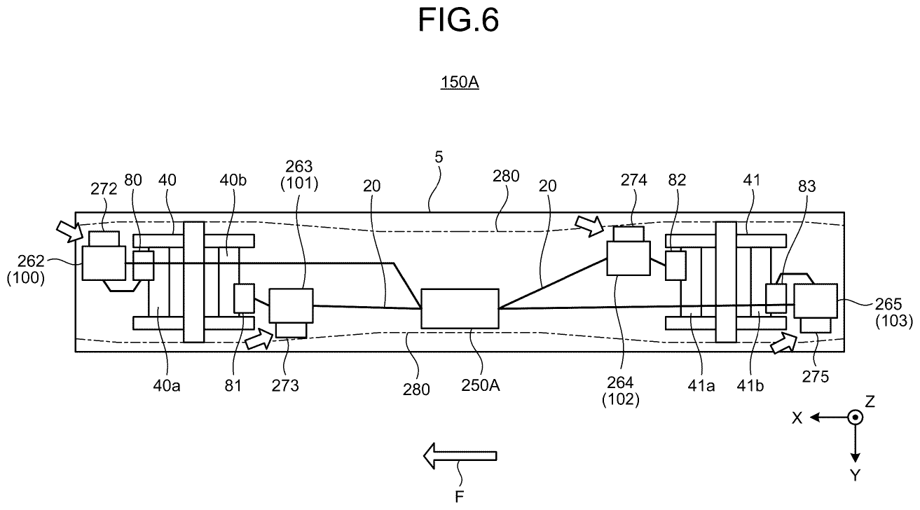

Next, exemplary installation of the individual control scheme will be described. FIG. 6 is a diagram for explaining third exemplary installation of the electric vehicle drive system according to the first embodiment. In the case of the individual control scheme as well, the components of the electric vehicle drive system 200 are dispersedly disposed under the floor of the electric vehicle 150A. Specifically, the housing 250A that houses the switch 10 and the reactor 11 is disposed in the center portion of the underfloor space. A housing 262 that houses the control device 100 is disposed near the cart 40 located on the front side of the electric vehicle 150A with respect to the forward direction F, specifically, disposed in front of the cart 40 and on the right side with respect to the forward direction F. A housing 263 that houses the control device 101 is disposed near the cart 40 located on the front side of the electric vehicle 150A with respect to the forward direction F, specifically, disposed behind the cart 40 and on the left side with respect to the forward direction F. Likewise, a housing 264 that houses the control device 102 is disposed near the cart 41 located on the rear side of the electric vehicle 150A with respect to the forward direction F, specifically, disposed in front of the cart 41 and on the right side with respect to the forward direction F. A housing 265 that houses the control device 103 is disposed near the cart 41 located on the rear side of the electric vehicle 150A with respect to the forward direction F, specifically, disposed behind the cart 41 and on the left side with respect to the forward direction F. Note that, in this description, the two control devices 100 and 101 that individually control the two electric motors 80 and 81 installed on the cart 40, which is the first cart, may each be referred to as the “first control device”. Also, the two control devices 102 and 103 that individually control the two electric motors 82 and 83 installed on the cart 41, which is the second cart, may each be referred to as the “second control device”.

On the housing 262, a cooler 272 for cooling the inverter 60 included in the control device 100 is attached so as to protrude in the −Y axis direction on a side surface of the housing 262. On the housing 263, a cooler 273 for cooling the inverter 60 included in the control device 101 is attached so as to protrude in the +Y axis direction on a side surface of the housing 263. On the housing 264, a cooler 274 for cooling the inverter 60 included in the control device 102 is attached so as to protrude in the −Y axis direction on a side surface of the housing 264. On the housing 265, a cooler 275 for cooling the inverter 60 included in the control device 103 is attached so as to protrude in the +Y axis direction on a side surface of the housing 265.

In the configuration of FIG. 6, on the cart 40, since the cooler 272 located on the windward side of the relative air flow and the cooler 273 located on the leeward side of the relative air flow are disposed with a separation distance corresponding to at least the length of the cart 40, it may be said that there are no heat generating objects close to each other. Accordingly, in the configuration of FIG. 6, a difference between the cooling conditions of the cooler 272 located on the windward side and the cooling conditions of the cooler 273 located on the leeward side can be reduced. This relationship also holds true between the coolers 274 and 275 on the cart 41. As a result, the configuration of FIG. 6 can avoid an increase in the size of the control devices 100 to 103 and an increase in the manufacturing cost of the control devices 100 to 103.

Moreover, in the configuration of FIG. 6, the housings 262 to 265 that house the control devices 100 to 103 can be disposed near the carts 40 and 41 where the width between the outfitting limit lines 280 is wide. Therefore, with the configuration of FIG. 6, even in the configuration of the individual control scheme, the control devices 100 to 103 can be disposed such that efficient cooling can be performed.

Moreover, in the configuration of FIG. 6, the components of the electric vehicle drive system 200 are not all housed in one housing, but are separately housed in the five housings 250A and 262 to 265. As a result, although the number of the housings is increased, the size of each of the housings is reduced, so that the housings can be disposed with effective use of an empty space under the floor.

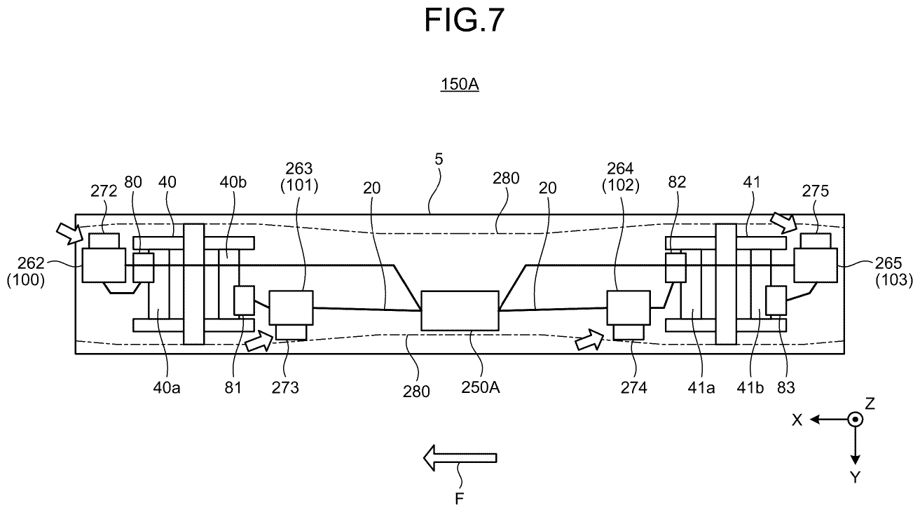

FIG. 7 is a diagram for explaining fourth exemplary installation of the electric vehicle drive system according to the first embodiment. In FIG. 6, on the respective carts 40 and 41, the housings 262 and 263 that house the control devices 100 and 101 are disposed at diametrically opposite positions, that is, positioned diagonally on the cart 40, and the housings 264 and 265 that house the control devices 102 and 103 are disposed at diametrically opposite positions, that is, positioned diagonally on the cart 41, and also the housing 263 that houses the control device 101 and the housing 264 that houses the control device 102 are disposed at diametrically opposite positions as viewed from the center portion of the underfloor space. On the other hand, in FIG. 7, on each of the carts 40 and 41, the housings that house the respective control devices are disposed at the diametrically opposite positions as described above, but the housing 263 that houses the control device 101 and the housing 264 that houses the control device 102 are disposed in line with each other in the forward direction F.

As illustrated in FIG. 7, even when the cooler 273 located on the windward side and the cooler 274 located on the leeward side are disposed in line with each other, the separation distance between the cooler 273 on the windward side and the cooler 274 on the leeward side is substantially the same as that in the case of FIG. 6. That is, since the cooler 273 on the windward side and the cooler 274 on the leeward side are disposed with a sufficient separation distance, it may be said that there are no heat generating objects close to each other. Therefore, the exemplary installation of FIG. 7 can also obtain an effect equivalent to that of the exemplary installation of FIG. 6.

Note that, in the case of the individual control scheme, exemplary installations other than those in FIGS. 6 and 7 are also conceivable, and any configuration may be adopted as long as the four control devices 100 to 103 are dispersedly disposed near the cart 40 located on front side of the electric vehicle 150A with respect to the forward direction F and near the cart 41 located on the rear side of the electric vehicle with respect to the forward direction F.

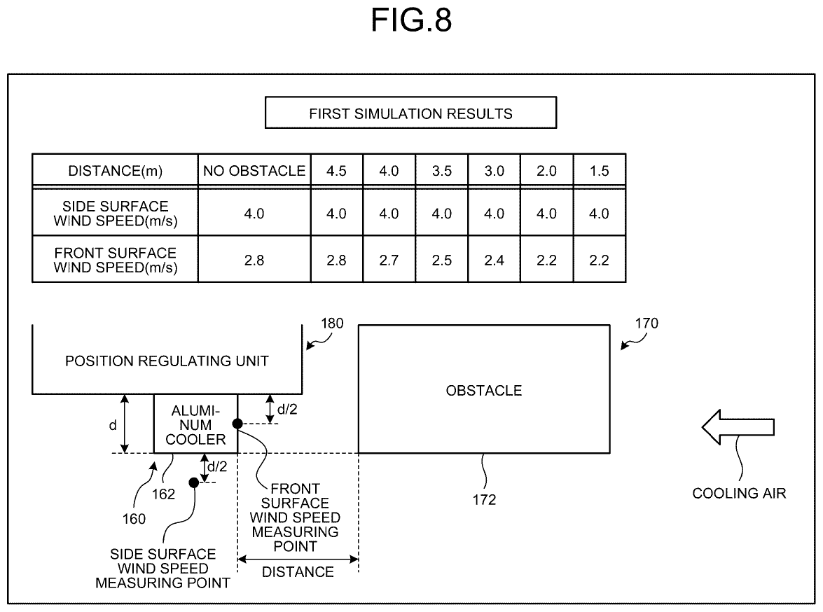

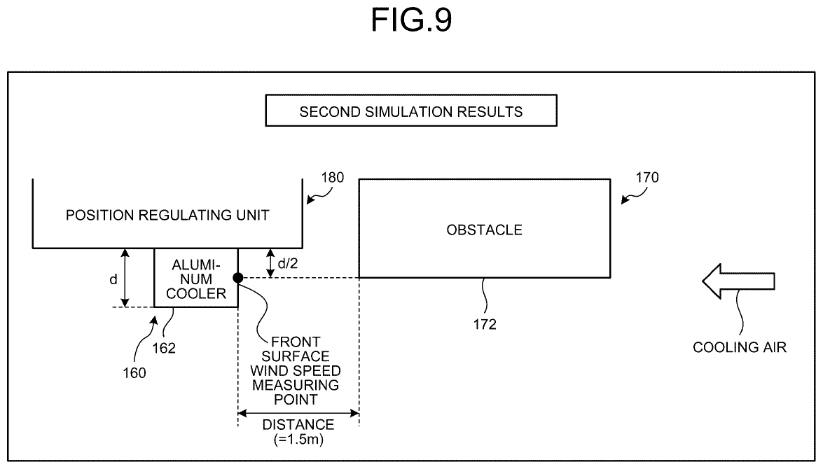

Next, an influence of an obstacle on the relative air flow that flows to the cooler will be described with reference to FIGS. 8 and 9. FIG. 8 is a diagram illustrating results of a first verification test for explaining the influence of the obstacle on the relative air flow that flows to the cooler. FIG. 9 is a diagram illustrating results of a second verification test for explaining the influence of the obstacle on the relative air flow that flows to the cooler.

First, the first verification test will be described. In a lower part of FIG. 8, a test environment of the first verification test is schematically illustrated. In FIG. 8, an obstacle 170 is disposed on a windward side of cooling air, and an aluminum cooler 160 is disposed on a leeward side of the cooling air. FIG. 8 is a plan view, and the length of the obstacle 170 in the height direction is equal to the length of the aluminum cooler 160 in the height direction. The cooling air is blown by a blower not illustrated. The position of a side portion 162 of the aluminum cooler 160 is regulated by a position regulating unit 180. The side portion 162 is a portion located on a distal end side of the aluminum cooler 160 along the direction of the cooling air. In FIG. 8, the position of the side portion 162 along the direction of the cooling air is regulated so as to coincide with the position of a side portion 172 of the obstacle 170 along the direction of the cooling air. Moreover, the width of the aluminum cooler 160, that is, the length of the aluminum cooler 160 in a direction orthogonal to the cooling air is defined as “d”. At this time, a position that is “d/2” from the position regulating unit 180 on a surface of the aluminum cooler 160 receiving the cooling air was set as a “front surface wind speed measuring point”, and a position that is “d/2” from the side portion 162 of the aluminum cooler 160 was set as a “side surface wind speed measuring point”. Then, with “distance” that is the shortest distance between the obstacle 170 and the aluminum cooler 160 as a parameter, the wind speed was measured at the front surface wind speed measuring point and the side surface wind speed measuring point. In an upper part of FIG. 8, the test results of

the first verification test are illustrated in tabular form. The test results revealed the following.
(1) In order to obtain the wind speed equivalent to that in the case where the obstacle 170 was absent, the distance between the aluminum cooler 160 and the obstacle 170 needed to be 4.5 m.
(2) When the distance between the aluminum cooler 160 and the obstacle 170 was 1.5 m, the obtained front surface wind speed was about 80% (=2.2/2.8×100) of that when the obstacle 170 was absent.

Next, the second verification test will be described. In the second verification test, as illustrated in FIG. 9, the distance between the aluminum cooler 160 and the obstacle 170 is set to 1.5 m, and the position of the front surface wind speed measuring point is set to be aligned with the side portion 172 of the obstacle 170. That is, the aluminum cooler 160 in FIG. 9 is regulated at a position protruding by “d/2” in the direction orthogonal to the direction of the cooling air as compared with FIG. 8. In this state, the wind speed at the front surface wind speed measuring point was measured for the case where the obstacle 170 was present and the case where the obstacle 170 was absent.

Although the test results are not illustrated, when the test was conducted under the test environment of FIG. 9, there was no change in the wind speed at the front surface wind speed measuring point between the case where the obstacle 170 was present and the case where the obstacle 170 was absent. That is, the second verification test obtained the result that the wind speed at the front surface wind speed measuring point was equal between the case where the obstacle 170 was present and the case where the obstacle 170 was absent.

As described above, in the configuration of the conventional technique illustrated in FIG. 2, the length of the housing 250 to which the two coolers 253 and 254 are attached in the direction of the length of the car is at most under 2 m. Thus, the distance between the two coolers 253 and 254 is considered to be about 1.5 m or 1.5 m or less. Therefore, the point of view of the conventional technique that the cooling performance of the cooler 254 located on the leeward side of the relative air flow is affected by the cooler 253 located on the windward side of the relative air flow is consistent with the results of the verification tests described above.

On the other hand, looking at the configuration of the present application, first, in the cart control scheme, the cooler 270 located on the windward side and the cooler 271 located on the leeward side are disposed with the sufficient separation distance. Also, the coolers 270 and 271 are disposed near the respective carts 40 and 41 where the width between the outfitting limit lines 280 is wide, and thus can be disposed at the positions hardly affected by an obstacle.

In the individual control scheme, the coolers 272 and 274 located on the windward side and the coolers 273 and 275 located on the leeward side on the respective carts 40 and 41 are disposed with the sufficient separation distances. Also, the coolers 272 to 275 are disposed near the corresponding cart 40 or 41 where the width between the outfitting limit lines 280 is wide, and thus can be disposed at the positions hardly affected by an obstacle.

As described above, the electric vehicle drive system according to the first embodiment includes the plurality of the control devices that each control at least one of the four electric motors that drive the four axles of the two carts of the electric vehicle. Each of the control devices includes the inverter that supplies power to at least one of the electric motors, and the controller that controls the inverter. The inverter is housed in the housing together with the controller, the housings each house at least one of the control devices, and the cooler that cools the inverter using the relative air flow generated by traveling of the electric vehicle is attached to each of the housings. Then, the plurality of the control devices are dispersedly disposed near the first cart located on the front side of the electric vehicle with respect to the forward direction and near the second cart located on the rear side of the electric vehicle with respect to the forward direction. According to the electric vehicle drive system configured as described above, the cooler located on the leeward side can be disposed while securing the sufficient separation distance from the cooler located on the windward side. Moreover, in the electric vehicle drive system according to the first embodiment, the cooler located on the leeward side and the cooler located on the windward side are disposed near the first and second carts where the width between the outfitting limit lines is wider than that of the center portion of the underfloor space, whereby the coolers can be disposed at the positions hardly affected by an obstacle. As a result, the electric vehicle drive system can be obtained in which the control devices can be flexibly disposed in the limited space of the electric vehicle such that efficient cooling can be performed.

The above configuration can be applied to the electric vehicle drive system of the cart control scheme in which the plurality of the control devices include the one first control device that controls the two electric motors installed on the first cart and the one second control device that controls the two electric motors installed on the second cart. In this cart control scheme, the housing that houses the first control device can be disposed behind the first cart with respect to the forward direction, and the housing that houses the second control device can be disposed in front of the second cart with respect to the forward direction.

Moreover, the above configuration can be applied to the electric vehicle drive system of the individual control scheme in which the plurality of the control devices include the two first control devices that individually control the two electric motors installed on the first cart and the two second control devices that individually control the two electric motors installed on the second cart. In this individual control scheme, the housing that houses one of the two first control devices can be disposed in front of the first cart with respect to the forward direction, the housing that houses the other of the two first control devices can be disposed behind the first cart with respect to the forward direction, the housing that houses one of the two second control devices can be disposed in front of the second cart with respect to the forward direction, and the housing that houses the other of the two second control devices can be disposed behind the second cart with respect to the forward direction. Alternatively, the two housings that house the one and the other of the two first control devices may be disposed behind the first cart with respect to the forward direction, and the two housings that house the one and the other of the two second control devices may be disposed in front of the second cart with respect to the forward direction.

Moreover, in the above configuration, the plurality of the coolers that house the first and second control devices can be attached to the housings so as to protrude in a first direction perpendicular to both the forward direction of the electric vehicle and a vertical direction of the car of the electric vehicle.

### Second Embodiment

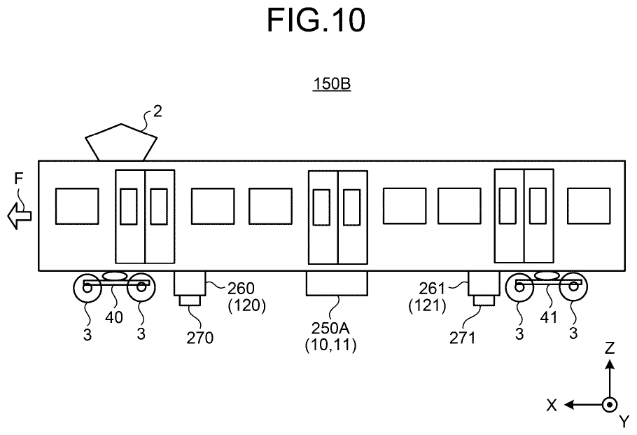

FIG. 10 is a diagram for explaining exemplary installation of an electric vehicle drive system according to a second embodiment. FIG. 10 is the diagram of an electric vehicle 150B according to the second embodiment as viewed from a side surface side thereof toward the negative direction of the Y axis. Moreover, FIG. 10 illustrates the exemplary installation of the cart control scheme. Note that components identical or equivalent to those in FIG. 3 are denoted by the same reference numerals as those assigned to the corresponding components in FIG. 3.

Differences between the electric vehicle 150B according to the second embodiment illustrated in FIG. 10 and the electric vehicle 150A according to the first embodiment illustrated in FIG. 3 include the installation position and the protruding direction of the coolers 270 and 271. In the electric vehicle 150A illustrated in FIG. 3, the coolers 270 and 271 are each attached so as to protrude in the +Y axis direction or the −Y axis direction on the side surface of the corresponding housing 260 or 261. Meanwhile, in the electric vehicle 150B illustrated in FIG. 10, the coolers 270 and 271 are each attached so as to protrude in the −Z axis direction on a lower surface of the corresponding housing 260 or 261.

In the configuration of FIG. 10 as well, the cooler 270 located on the windward side of the relative air flow and the cooler 271 located on the leeward side of the relative air flow are disposed with a sufficient separation distance, whereby an effect equivalent to that of the configuration of FIG. 3 can be obtained. Also, regarding the empty space under the floor, in a case where there is not much room in the Y axis direction, which is the horizontal width direction of the car, and there is room in the Z axis direction, which is the height direction of the car, the configuration of FIG. 10 may be easier to design than the configuration of FIG. 3. Therefore, the exemplary installations of FIGS. 5 to 7 may also adopt the configuration of the second embodiment.

The configurations illustrated in the above embodiments each illustrate an example so that another known technique can be combined, the embodiments can be combined together, or the configurations can be partially omitted and/or modified without departing from the scope of the present disclosure.

### REFERENCE SIGNS LIST

1 overhead line; 2 current collector; 3 wheel; 4 rail; 5 car; 10 switch; 11 reactor; 20 electric wire; 30 controller; 40, 41 cart; 40a, 40b, 41a, 41b axle; 50 capacitor; 52 discharge circuit; 60 inverter; 60U, 60V, 60W, 60X, 60Y, 60Z semiconductor element; 80, 81, 82, 83 electric motor; 100, 101, 102, 103, 120, 121, 251, 252 control device; 150, 150A, 150B electric vehicle; 160 aluminum cooler; 162, 172 side portion; 170 obstacle; 180 position regulating unit; 200 electric vehicle drive system; 250, 250A, 260, 261, 262, 263, 264, 265 housing; 253, 254, 270, 271, 272, 273, 274, 275 cooler; 280 outfitting limit line; F forward direction; N negative terminal; P positive terminal.

1. An electric vehicle drive system comprising a plurality of control devices to each control at least one of four electric motors that drive four axles of two carts of an electric vehicle, wherein
the control devices each include:
an inverter to supply power to at least one of the electric motors; and
a controller to control the inverter,
the inverter is housed in a housing together with the controller, the housing being disposed near one of the carts where outfitting limit lines are wider than outfitting limit lines at a center portion of an underfloor space,
the housing houses at least one of the control devices,
a cooler to cool the inverter using a relative air flow generated by traveling of the electric vehicle is attached to the housing, and
the plurality of the control devices are dispersedly disposed near a first cart located on a front side of the electric vehicle with respect to a forward direction and near a second cart located on a rear side with respect to the forward direction.

2. The electric vehicle drive system according to claim 1, wherein the plurality of the control devices include one first control device to control two of the electric motors installed on the first cart and one second control device to control two of the electric motors installed on the second cart.

3. The electric vehicle drive system according to claim 2, wherein
the housing that houses the first control device is disposed behind the first cart with respect to the forward direction, and
the housing that houses the second control device is disposed in front of the second cart with respect to the forward direction.

4. The electric vehicle drive system according to claim 1, wherein the plurality of the control devices include two first control devices to individually control two of the electric motors installed on the first cart and two second control devices to individually control two of the electric motors installed on the second cart.

5. The electric vehicle drive system according to claim 4, wherein
the housing that houses one of the two first control devices is disposed in front of the first cart with respect to the forward direction,
the housing that houses another of the two first control devices is disposed behind the first cart with respect to the forward direction,
the housing that houses one of the two second control devices is disposed in front of the second cart with respect to the forward direction, and
the housing that houses another of the two second control devices is disposed behind the second cart with respect to the forward direction.

6. The electric vehicle drive system according to claim 4, wherein
two of the housings that house one and another of the two first control devices are disposed behind the first cart with respect to the forward direction, and
two of the housings that house one and another of the two second control devices are disposed in front of the second cart with respect to the forward direction.

7. The electric vehicle drive system according to claim 2, wherein
a plurality of the coolers that house the first and second control devices are each attached to the housing so as to protrude in a first direction perpendicular to both the forward direction and a vertical direction of a car of the electric vehicle.

8. The electric vehicle drive system according to claim 2, wherein
a plurality of the coolers that house the first and second control devices are each attached to the housing so as to protrude in a vertically downward direction of a car of the electric vehicle.

9. The electric vehicle drive system according to claim 3, wherein
a plurality of the coolers that house the first and second control devices are each attached to the housing so as to protrude in a first direction perpendicular to both the forward direction and a vertical direction of a car of the electric vehicle.

10. The electric vehicle drive system according to claim 4, wherein
a plurality of the coolers that house the first and second control devices are each attached to the housing so as to protrude in a first direction perpendicular to both the forward direction and a vertical direction of a car of the electric vehicle.

11. The electric vehicle drive system according to claim 5, wherein
a plurality of the coolers that house the first and second control devices are each attached to the housing so as to protrude in a first direction perpendicular to both the forward direction and a vertical direction of a car of the electric vehicle.

12. The electric vehicle drive system according to claim 6, wherein
a plurality of the coolers that house the first and second control devices are each attached to the housing so as to protrude in a first direction perpendicular to both the forward direction and a vertical direction of a car of the electric vehicle.

13. The electric vehicle drive system according to claim 3, wherein
a plurality of the coolers that house the first and second control devices are each attached to the housing so as to protrude in a vertically downward direction of a car of the electric vehicle.

14. The electric vehicle drive system according to claim 4, wherein
a plurality of the coolers that house the first and second control devices are each attached to the housing so as to protrude in a vertically downward direction of a car of the electric vehicle.

15. The electric vehicle drive system according to claim 5, wherein
a plurality of the coolers that house the first and second control devices are each attached to the housing so as to protrude in a vertically downward direction of a car of the electric vehicle.

16. The electric vehicle drive system according to claim 6, wherein
a plurality of the coolers that house the first and second control devices are each attached to the housing so as to protrude in a vertically downward direction of a car of the electric vehicle.
